(19) United States
(12) Patent Application Publication
(10) Pub. No.: US 2026/0270469 A1
(43) Pub. Date: Sep. 10, 2026

(54) Method and Apparatus Using Affine Motion Estimation with Control-Point Motion Vector Refinement

(71) Applicant: MEDIATEK INC., Hsinchu City (TW)

(72) Inventors: Chen-Yen LAI, Hsinchu City (TW); Tzu-Der CHUANG, Hsinchu City (TW); Ching-Yeh CHEN, Hsinchu City (TW); Chih-Wei HSU, Hsinchu City (TW); Chih-Hsuan LO, Hsinchu City (TW)

(21) Appl. No.: 18/881,484

(22) PCT Filed: May 30, 2023
(86) PCT No.: PCT/CN2023/097023

§ 371 Date: Jan. 6, 2025

Related U.S. Application Data
(60) Provisional application No. 63/368,779, filed on Jul. 19, 2022.
(60) Provisional application No. 63/368,906, filed on Jul. 20, 2022.

(51) Int. Cl. H04N 19/54; H04N 19/105; H04N 19/176; H04N 19/196; H04N 19/513

(52) U.S. Cl. CPC H04N 19/54; H04N 19/105; H04N 19/176; H04N 19/196; H04N 19/521

(57) ABSTRACT

Methods and apparatus for video coding using CPMVs (Control-Point Motion Vectors) refinement or ARMC (Adaptive Reordering of Merge Candidates) for an affine coded block. According to this method, two or more CPMVs or said two or more corner-subblock motions independently to generate two or more refined CPMVs. A merge list or an AMVP (Advanced Motion Vector Prediction) list comprising said one or more refined CPMVs is generated for coding the current block. According to another method, an affine model determined for the current block is applied to neighbouring reference subblocks of the current block to derive affine-transformed reference blocks of neighbouring reference subblocks. One or more templates are determined based on the affine-transformed reference blocks. The templates are used for reordering a set of merge candidates, which is used for coding the current block.

### CROSS REFERENCE TO RELATED APPLICATIONS

The present invention claims priority to U.S. Provisional Patent Application, Ser. No. 63/368,779, filed on Jul. 19, 2022 and U.S. Provisional Patent Application, Ser. No. 63/368,906, filed on Jul. 20, 2022. The U.S. Provisional Patent Applications are hereby incorporated by reference in their entireties.

### FIELD OF THE INVENTION

The present invention relates to video coding using motion estimation and motion compensation. In particular, the present invention relates to control-point motion vector refinement using a decoder-derived motion vector refinement related method or template matching method.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology —Coded representation of immersive media —Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Affine Optical Flow

When the coding unit (CU) is coded with affine mode, the coding unit is partitioned into 4×4 subblocks and for each subblock, one motion vector is derived based on the affine model and motion compensation is performed to generate the corresponding predictors. The reason of using 4×4 block as one subblock, instead of using other smaller size, is to achieve a good trade-off between the computational complexity of motion compensation and coding efficiency. In order to improve the coding efficiency, several methods are disclosed in JVET-N0236 (J. Luo, et al., “CE2-related: Prediction refinement with optical flow for affine mode”, Joint Video Experts Team (JVET) of ITU-T SG 16 WP 3 and ISO/IEC JTC 1/SC 29/WG 11, 14th Meeting: Geneva, CH, 19-27 Mar. 2019, Document: JVET-N0236), JVET-N0261 (K. Zhang, et al., “CE2-1.1: Interweaved Prediction for Affine Motion Compensation”, Joint Video Experts Team (JVET) of ITU-T SG 16 WP 3 and ISO/IEC JTC 1/SC 29/WG 11, 14th Meeting: Geneva, CH, 19-27 Mar. 2019, Document: JVET-N0261), and JVET-N0262 (H. Huang, et al., “CE9-related: Disabling DMVR for non-equal weight BPWA”, Joint Video Experts Team (JVET) of ITU-T SG 16 WP 3 and ISO/IEC JTC 1/SC 29/WG 11, 14th Meeting: Geneva, CH, 19-27 Mar. 2019, Document: JVET-N0262).

In JVET-N0236, to achieve a finer granularity of motion compensation, the contribution proposes a method to refine the sub-block based affine motion compensated prediction with optical flow. After the sub-block based affine motion compensation is performed, luma prediction sample is refined by adding a difference derived by the optical flow equation. The proposed Prediction Refinement with Optical Flow (PROF) is described as the following four steps. Step 1), the sub-block-based affine motion compensation is performed to generate sub-block prediction I(i,j). Step 2), the spatial gradients gₓ(i,j) and g_{y}(i,j) of the sub-block prediction are calculated at each sample location using a 3-tap filter [−1, 0, 1].

$${g}_{x} ( i , j ) = I ( i + 1 , j ) - I ( i - 1 , j ) , and$$

$${g}_{y} ( i , j ) = I ( i , j + 1 ) - I ( i , j - 1 ) .$$

The sub-block prediction is extended by one pixel on each side for the gradient calculation. To reduce the memory bandwidth and complexity, the pixels on the extended borders are copied from the nearest integer pixel position in the reference picture. Therefore, additional interpolation for padding region is avoided. Step 3), the luma prediction refinement is calculated by the optical flow equation.

$$Δ I ( i , j ) = {g}_{x} ( i , j ) * Δ {v}_{x} ( i , j ) + {g}_{y} ( i , j ) * Δ {v}_{y} ( i , j )$$

where the Δv(i, j) is the difference between pixel MV computed for sample location (i,j), denoted by v(i, j), and the sub-block MV, denoted as v_{SB} (212), of the sub-block 220 of block 210 to which pixel (i,j) belongs, as shown in FIG. 2. In FIG. 2, sub-block 222 corresponds to a reference sub-block for sub-block 220 as pointed by the motion vector v_{SB} (212). The reference sub-block 222 represents a reference sub-block resulted from translational motion of block 220. Reference sub-block 224 corresponds to a reference sub-block with PROF. The motion vector for each pixel is refined by Δv(i,j). For example, the refined motion vector v(i, j) 214 for the top-left pixel of the sub-block 220 is derived based on the sub-block MV v_{SB} (212) modified by Δᵥ(i, j) 216.

Since the affine model parameters and the pixel locations relative to the sub-block center are not changed from sub-block to sub-block, Δv(i,j) can be calculated for the first sub-block, and reused for other sub-blocks in the same CU. Let x and y be the horizontal and vertical offset from the pixel location to the center of the sub-block, Δv(x, y) can be derived by the following equation,

$$\{ \begin{matrix}Δ {v}_{x} ( x , y ) = c * x + d * y \\ Δ {v}_{y} ( x , y ) = e * x + f * y\end{matrix} .$$

For 4-parameter affine model, parameters c and e can be derived as:

$$\{ \begin{matrix}c = f = \frac{{v}_{1 x} - {v}_{0 x}}{w} \\ e = - d = \frac{{v}_{1 y} - {v}_{0 y}}{w} .\end{matrix}$$

For 6-parameter affine model, parameters c, d, e and f can be derived as:

$$\{ \begin{matrix}c = \frac{{v}_{1 x} - {v}_{0 x}}{w} \\ d = \frac{{v}_{2 x} - {v}_{0 x}}{h} \\ e = \frac{{v}_{1 y} - {v}_{0 y}}{w} \\ f = \frac{{v}_{2 y} - {v}_{0 y}}{h}\end{matrix} .$$

where (v₀ₓ, v_{0y}), (v₁ₓ v_{1y}), (v₂ₓ, v_{2y}) are the top-left, top-right and bottom-left control point motion vectors, w and h are the width and height of the CU. Step 4), finally, the luma prediction refinement is added to the sub-block prediction I(i,j). The final prediction I′ is generated as the following equation.

$${I}^{′} ( i , j ) = I ( i , j ) + Δ I ( i , j ) .$$

In JVET-N0261, another sub-block based affine mode, interweaved prediction, was proposed in FIG. 3. With the interweaved prediction, a coding block 310 is divided into sub-blocks with two different dividing patterns (320 and 322). Then two auxiliary predictions (P₀ 330 and P₁ 332) are generated by affine motion compensation with the two dividing patterns. The final prediction 340 is calculated as a weighted-sum of the two auxiliary predictions (330 and 332). To avoid motion compensation with 2×H or W×2 block size, the interweaved prediction is only applied to regions where the size of sub-blocks is 4×4 for both the two dividing patterns as shown in FIG. 4.

According to the method disclosed in JVET-N0261, the 2×2 subblock based affine motion compensation is only applied to uni-prediction of luma samples and the 2×2 subblock motion field is only used for motion compensation. The storage of motion vector field for motion prediction etc., is still 4×4 subblock based. If the bandwidth constrain is applied, the 2×2 subblock based affine motion compensation is disabled when the affine motion parameters do not satisfy certain criterion.

In JVET-N0273 (H. Huang, et al., “CE9-related: Disabling DMVR for non-equal weight BPWA”, Joint Video Experts Team (JVET) of ITU-T SG 16 WP 3 and ISO/IEC JTC 1/SC 29/WG 11, 14th Meeting: Geneva, CH, 19-27 Mar. 2019, Document: JVET-N0262), the 2×2 subblock based affine motion compensation is only applied to uni-prediction of luma samples and the 2×2 subblock motion field is only used for motion compensation. If bandwidth constrain is applied, the 2×2 subblock based affine motion compensation is disabled when the affine motion parameters don't satisfy certain criterion.

### Affine Model

Motion occurs across pictures along temporal axis can be described by a number of different models. Assuming A(x, y) be the original pixel at location (x, y) under consideration, A′ (x′, y′) be the corresponding pixel at location (x′, y′) in a reference picture for a current pixel A(x, y), the affine motion models are described as follows.

The affine model is capable of describing two-dimensional block rotations as well as two-dimensional deformations to transform a square (or rectangles) into a parallelogram. This model can be described as follows:

$${x}^{′} = {a}_{0} + {a}_{1} * x + {a}_{2} * y , and \qquad ( 1 )$$

$${y}^{′} = {b}_{0} + {b}_{1} * x + {b}_{2} * y .$$

In contribution ITU-T13-SG16-C1016 submitted to ITU-VCEG (Lin, et al., “Affine transform prediction for next generation video coding”, ITU-U, Study Group 16, Question Q6/16, Contribution C1016, September 2015, Geneva, CH), a four-parameter affine prediction is disclosed, which includes the affine Merge mode. When an affine motion block is moving, the motion vector field of the block can be described by two control point motion vectors or four parameters as follows, where (vx, vy) represents the motion vector

$$\{ \begin{matrix}{x}^{′} = ax + by + e \\ {y}^{′} = - bx + ay + f \\ vx = x - {x}^{′} \\ vy = y - {y}^{′}\end{matrix} {⇒}^{△} \{ \begin{matrix}vx = ( 1 - a ) x - by - e \\ vy = ( 1 - a ) y + bx - f\end{matrix} \qquad ( 2 )$$

An example of the four-parameter affine model is shown in FIG. 5, where a corresponding reference block 520 for the current block 510 is located according to an affine model with two control-point motion vectors (i.e., v₀ and v₁). The transformed block is a rectangular block. The motion vector field of each point in this moving block can be described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 3 )$$

$$or$$

$$\{ \begin{matrix}{v}_{x} = \frac{( {v}_{1 x} - {v}_{0 x} )}{w} x - \frac{( {v}_{2 x} - {v}_{0 x} )}{h} y + {v}_{0 x} \\ {v}_{y} = \frac{( {v}_{1 y} - {v}_{0 y} )}{w} x + \frac{( {v}_{2 y} - {v}_{0 y} )}{h} y + {v}_{0 y}\end{matrix} \qquad ( 4 )$$

In the above equations, (v₀ₓ, v_{0y}) is the control point motion vector (i.e., v₀) at the upper-left corner of the block, and (v₁ₓ, v_{1y}) is another control point motion vector (i.e., v₁) at the upper-right corner of the block. When the MVs of two control points are decoded, the MV of each 4×4 block of the block can be determined according to the above equation. In other words, the affine motion model for the block can be specified by the two motion vectors at the two control points. Furthermore, while the upper-left corner and the upper-right corner of the block are used as the two control points, other two control points may also be used. An example of motion vectors for a current block can be determined for each 4×4 sub-block based on the MVs of the two control points according to equation (3).

In contribution ITU-T13-SG16-C1016, for an Inter mode coded CU, an affine flag is signaled to indicate whether the affine Inter mode is applied or not when the CU size is equal to or larger than 16×16. If the current block (e.g., current CU) is coded in affine Inter mode, a candidate MVP pair list is built using the neighbor valid reconstructed blocks. FIG. 6 illustrates the neighboring block set used for deriving the corner derived affine candidate. As shown in FIG. 6, the v̅₀ corresponds to motion vector of the block V0 at the upper-left corner of the current block 610, which is selected from the motion vectors of the neighboring block A₀ (referred as the above-left block), A₁ (referred as the inner above-left block) and A₂ (referred as the lower above-left block), and the v̅₁ corresponds to motion vector of the block V1 at the upper-right corner of the current block 610, which is selected from the motion vectors of the neighboring block B₀(referred as the above block) and B₁ (referred as the above-right block).

In contribution ITU-T13-SG16-C1016, an affine Merge mode is also proposed. If the current block 610 is a Merge coded PU, the neighboring five blocks (C0, B0, B1, C1, and A0 blocks in FIG. 6) are checked to determine whether any of them is coded in affine Inter mode or affine Merge mode. If yes, an affine flag is signaled to indicate whether the current PU is affine mode. When the current PU is applied in affine merge mode, it gets the first block coded with affine mode from the valid neighbor reconstructed blocks. The selection order for the candidate block is from left block (C0), above block (B0), above-right block (B1), left-bottom block (C1) to above-left block (A0). In other words, the search order is C0→B0→B1→C1→A0 as shown in FIG. 6. The affine parameters of the affine coded blocks are used to derive the v₀ and v₁ for the current PU. In the example of FIG. 6, the neighboring blocks (i.e., C0, B0, B1, C1, and A0) used to construct the control point MVs for affine motion model are referred as a neighboring block set in this disclosure.

In affine motion compensation (MC), the current block is divided into multiple 4×4 sub-blocks. For each sub-block, the center point (2, 2) is used to derive a MV by using equation (3) for this sub-block. For the MC of this current, each sub-block performs a 4×4 sub-block translational MC.

In HEVC, the decoded MVs of each PU are down-sampled with a 16:1 ratio and stored in the temporal MV buffer for the MVP derivation of the following frames. For a 16×16 block, only the top-left 4×4 MV is stored in the temporal MV buffer and the stored MV represents the MV of the whole 16×16 Block.

### Bi-directional Optical Flow (BIO)

Bi-directional optical flow (BIO) is a motion estimation/compensation technique disclosed in JCTVC-C204 (E. Alshina, et al., Bi-directional opticalflow, Joint Collaborative Team on Video Coding (JCT-VC) of ITU-T SG 16 WP 3 and ISO/IEC JTC 1/SC 29/WG 11, 3rd Meeting: Guangzhou, CN, 7-15 October, 2010, Document: JCTVC-C204) and VCEG-AZ05 (E. Alshina, et al., Known tools performance investigation for next generation video coding, ITU-T SG 16 Question 6, Video Coding Experts Group (VCEG), 52nd Meeting: 19-26 Jun. 2015, Warsaw, Poland, Document: VCEG-AZ05). BIO derives the sample-level motion refinement based on the assumptions of optical flow and steady motion as shown in FIG. 7, where a current pixel 722 in a B-slice (bi-prediction slice) 720 is predicted by one pixel in reference picture 0 (730) and one pixel in reference picture 1 (710). As shown in FIG. 7, the current pixel 722 is predicted by pixel B (712) in reference picture 1 (710) and pixel A (732) in reference picture 0 (730). In FIG. 7, vₓ and v_{y} are pixel displacement vector (714 or 734) in the x-direction and y-direction, which are derived using a bi-direction optical flow (BIO) model. It is applied only for truly bi-directional predicted blocks, which is predicted from two reference pictures corresponding to the previous picture and the latter picture. In VCEG-AZ05, BIO utilizes a 5×5 window to derive the motion refinement of each sample. Therefore, for an N×N block, the motion compensated results and corresponding gradient information of an (N+4)×(N+4) block are required to derive the sample-based motion refinement for the N×N block. According to VCEG-AZ05, a 6-Tap gradient filter and a 6-Tap interpolation filter are used to generate the gradient information for BIO. Therefore, the computational complexity of BIO is much higher than that of traditional bi-directional prediction. In order to further improve the performance of BIO, the following methods are proposed.

In a conventional bi-prediction in HEVC, the predictor is generated using the following equation, where P⁽⁰⁾ and P⁽¹⁾ are the list0 and list1 predictor, respectively.

$${P}_{C o n v e n t i o n a l} [ i , j ] = ( {P}^{( 0 )} [ i , j ] + {P}^{( 1 )} [ i , j ] + 1 ) >> 1$$

In JCTVC-C204 and VECG-AZ05, the BIO predictor is generated using the following equation:

$${P}_{OpticalFlow} = ( {P}^{( 0 )} [ i , j ] + {P}^{( 1 )} [ i , j ] + {v}_{x} [ i , j ] ( {I}_{x}^{( 0 )} - {I}_{x}^{( 1 )} [ i , j ] ) + {v}_{y} [ i , j ] ( {I}_{y}^{( 0 )} - {I}_{y}^{( 1 )} [ i , j ] ) + 1 ) >> 1$$

In the above equation, Iₓ⁽⁰⁾ and Iₓ⁽¹⁾ represent the x-directional gradient in list0 and list1 predictor, respectively; I_{y}⁽⁰⁾ and I_{y}⁽¹⁾ represent the y-directional gradient in list0 and list1 predictor, respectively; vₓ and v_{y} represent the offsets or displacements in x- and y-direction, respectively. The derivation process of vₓ and v_{y} is shown in the following. First, the cost function is defined as diffCost(x, y) to find the best values vₓ and v_{y}. In order to find the best values vₓ and v_{y} to minimize the cost function, diffCost(x, y), one 5×5 window is used. The solutions of vₓ and v_{y} can be represented by using S₁, S₂, S₃, S₅, and S₆.

$$\begin{matrix}diffCost ( x , y ) = {\sum }_{Ω} ( {P}^{0} ( x , y ) + {v}_{x} \frac{\partial {P}^{0} ( x , y )}{\partial x} + {v}_{y} \frac{\partial {P}^{0} ( x , y )}{\partial y} - \\ {( {P}^{1} ( x , y ) - {v}_{x} \frac{\partial {P}^{1} ( x , y )}{\partial x} - {v}_{y} \frac{\partial {P}^{1} ( x , y )}{\partial y} ) )}^{2} , \\ = {\sum }_{Ω} ( {P}^{0} ( x , y ) - {P}^{1} ( x , y ) + {V}_{X} ( \frac{\partial {P}^{0} ( x , y )}{\partial x} + \\ {\frac{\partial {P}^{1} ( x , y )}{\partial x} ) + {v}_{y} ( \frac{\partial {P}^{0} ( x , y )}{\partial y} + \frac{\partial {P}^{1} ( x , y )}{\partial y} ) )}^{2} .\end{matrix}$$

The minimum cost function, min diffCost(x,y) can be derived according to:

$$\frac{\partial diffCost ( x , y )}{\partial {v}_{X}} = 0 , \frac{\partial diffCos t ( x , y )}{\partial {v}_{y}} = 0.$$

By solving equations (3) and (4), vₓ and v_{y} can be solved according to the following equation:

$${v}_{x} = \frac{{S}_{3} {S}_{5} - {S}_{2} {S}_{6}}{{S}_{1} {S}_{5} - {S}_{2} {S}_{2}} , {v}_{y} = \frac{{S}_{1} {S}_{6} - {S}_{3} {S}_{2}}{{S}_{1} {S}_{5} - {S}_{2} {S}_{2}}$$

where,

$${S}_{1} = {\sum }_{Ω} {( \frac{\partial {P}^{0} ( x , y )}{\partial x} + \frac{\partial {P}^{1} ( x , y )}{\partial x} )}^{2} ,$$

$${S}_{2} = {\sum }_{Ω} ( \frac{\partial {P}^{0} ( x , y )}{\partial x} + \frac{\partial {P}^{1} ( x , y )}{\partial x} ) ( \frac{\partial {P}^{0} ( x , y )}{\partial y} + \frac{\partial {P}^{1} ( x , y )}{\partial y} )$$

$${S}_{3} = - {\sum }_{Ω} ( \frac{\partial {P}^{0} ( x , y )}{\partial x} + \frac{\partial {P}^{1} ( x , y )}{\partial x} ) ( {P}^{0} ( x , y ) - {P}^{1} ( x , y ) ) ,$$

$${S}_{5} = {\sum }_{Ω} {( \frac{\partial {P}^{0} ( x , y )}{\partial y} + \frac{\partial {P}^{1} ( x , y )}{\partial y} )}^{2}$$

$${S}_{6} = - {\sum }_{Ω} ( \frac{\partial {P}^{0} ( x , y )}{Φ} + \frac{\partial {P}^{1} ( x , y )}{Φ} ) ( {P}^{0} ( x , y ) - {P}^{1} ( x , y ) ) .$$

In the above equations,

$$\frac{\partial {P}^{0} ( x , y )}{\partial x}$$

corresponds to the x-direction gradient of a pixel at (x,y) in the list 0 picture,

$$\frac{\partial {P}^{1} ( x , y )}{\partial x}$$

corresponds to the x-direction gradient of a pixel at (x,y) in the list 1 picture,

$$\frac{\partial {P}^{0} ( x , y )}{\partial y}$$

corresponds to the y-direction gradient of a pixel at (x,y) in the list 0 picture, and

$$\frac{\partial {P}^{1} ( x , y )}{\partial y}$$

corresponds to the y-direction gradient of a pixel at (x,y) in the list 1 picture.

In some related art, the S₂ can be ignored, and vₓ and v_{y} can be solved according to

$${v}_{x} = \frac{{S}_{3}}{{S}_{1}} , {v}_{y} = \frac{{S}_{6} - {v}_{x} {S}_{2}}{{S}_{5}}$$

where,

$${S}_{1} = {\sum }_{Ω} {( \frac{\partial {P}^{0} ( x , y )}{\partial x} + \frac{\partial {P}^{1} ( x , y )}{\partial x} )}^{2} ,$$

$${S}_{2} = {\sum }_{Ω} ( \frac{\partial {P}^{0} ( x , y )}{\partial x} + \frac{\partial {P}^{1} ( x , y )}{\partial x} ) ( \frac{\partial {P}^{0} ( x , y )}{\partial y} + \frac{\partial {P}^{1} ( x , y )}{\partial y} )$$

$${S}_{3} = - {\sum }_{Ω} ( \frac{\partial {P}^{0} ( x , y )}{\partial x} + \frac{\partial {P}^{1} ( x , y )}{\partial x} ) ( {P}^{0} ( x , y ) - {P}^{1} ( x , y ) ) ,$$

$${S}_{5} = {\sum }_{Ω} {( \frac{\partial {P}^{0} ( x , y )}{\partial y} + \frac{\partial {P}^{1} ( x , y )}{\partial y} )}^{2}$$

$${S}_{6} = - {\sum }_{Ω} ( \frac{\partial {P}^{0} ( x , y )}{\partial y} + \frac{\partial {P}^{1} ( x , y )}{\partial y} ) ( {P}^{0} ( x , y ) - {P}^{1} ( x , y ) )$$

We can find that the required bit-depth is large in BIO process, especially for calculating S₁, S₂, S₃, S₅, and S₆. For example, if the bit-depth of pixel value in video sequences is 10 bits and the bit-depth of gradients is increased by fractional interpolation filter or gradient filter, then 16 bits are required to represent one x-directional gradient or one y-directional gradient. These 16 bits may be further reduced by gradient shift equal to 4, so one gradient needs 12 bits to represent the value. Even if the magnitude of gradient can be reduced to 12 bits by gradient shift, the required bit-depth of BIO operations is still large. One multiplier with 13 bits by 13 bits is required to calculate S₁, S₂, and S₅. And another multiplier with 13 bits by 17 bits is required to get S₃, and S₆. When the window size is large, more than 32 bits are required to represent S₁, S₂, S₃, S₅, and S₆.

Affine with DMVR (Decoder-Side Motion Vector Refinement)

In this JVET-AA0144 (Jie Chen, et al., “Non-EE2: DMVR for affine merge coded blocks”, Joint Video Experts Team (JVET) of ITU-T SG 16 WP 3 and ISO/IEC JTC 1/SC 29/WG 11, 27th Meeting, by teleconference, 13-22 Jul. 2022, Document: JVET-AA0144), a technology of using MP (Multi-Pass)-DMVR to refine affine CPMV is proposed. It is said that, generally, affine model can be described using the following equations

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 5 )$$

wherein(mvₓ, mv_{y}) is the motion vector at location (x, y), (mv₀ₓ, mv_{0y}) is the base MV representing the translation motion of the affine model, and

$$\frac{m {v}_{1 x} - m {v}_{0 x}}{W} , \frac{m {v}_{2 x} - m {v}_{0 x}}{H} , \frac{m {v}_{1 y} - m {v}_{0 y}}{W} and \frac{m {v}_{2 y} - m {v}_{0 y}}{H}$$

are four non-translation parameters which defines rotation, scaling and other non-translation motion of the affine model.

In ECM, besides 6-parameters affine model defined as in equation (5), we also have 4-parameters affine mode described as in equation (6) in which only two non-translation parameters are used:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} . \qquad ( 6 )$$

In JVET-AA0144, it is proposed to refine the base MV of the affine model of the coding block coded with the affine merge mode by only applying the first step of multi-pass DMVR. That is, we add a translation MV offset to all the CPMVs of the candidate in the affine merge list if the candidate meets the DMVR condition. The MV offset is derived by minimizing the cost of bilateral matching which is the same as conventional DMVR. The DMVR condition is also not changed.

The MV offset searching process is the same as the first pass of multi-pass DMVR in ECM. A 3×3 square search pattern is used to loop through the search range [−8, +8] in horizontal direction and [−8, +8] in vertical direction to find the best integer MV offset. A half pel search is then conducted around the best integer position and an error surface estimation is performed at last to find an MV offset with 1/16 precision.

The refined CPMV is stored for both spatial and temporal motion vector prediction as the multi-pass DMVR in ECM.

Some methods are proposed below to further improve the refinement of Affine CPMVs by MP-DMVR or template matching related algorithm.

### Adaptive Reordering of Merge Candidates (ARMC)

In JVET-V0099 (Na Zhang, et al., “AHG12: Adaptive Reordering of Merge Candidates with Template Matching”, Joint Video Experts Team (JVET) of ITU-T SG 16 WP 3 and ISO/IEC JTC 1/SC 29/WG 11, 22nd Meeting, by teleconference, 20-28 Apr. 2021, Document: JVET-V0099), an adaptive reordering of merge candidates with template matching (ARMC) method is proposed. The reordering method is applied to the regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5. Merge candidates in each subgroup are reordered ascendingly according to cost values based on template matching. For simplification, merge candidates in the last subgroup are not reordered with the exception that there is only one subgroup.

The template matching cost is measured by the sum of absolute differences (SAD) between samples of a template of the current block and their corresponding reference samples. The template comprises a set of reconstructed samples neighbouring to the current block. Reference samples of the template are located using the same motion information of the current block.

When a merge candidate utilizes bi-directional prediction, the reference samples of the template of the merge candidate are also generated by bi-prediction as shown in FIG. 8. In FIG. 8, block 812 corresponds to a current block in current picture 810, blocks 822 and 832 correspond to reference blocks in reference pictures 820 and 830 in list 0 and list 1 respectively. Templates 814 and 816 are for current block 812, templates 824 and 826 are for reference block 822, and templates 834 and 836 are for reference block 832. Motion vectors 840, 842 and 844 are merge candidates in list 0 and motion vectors 850, 852 and 854 are merge candidates in list 1.

When a merge candidate utilizes bi-directional prediction, the reference samples of the template of the merge candidate are also generated by bi-prediction as shown in FIG. 8.

For subblock-based merge candidates with subblock size equal to Wsub×Hsub, the above template comprises several sub-templates with the size of Wsub×1, and the left template comprises several sub-templates with the size of 1×Hsub. As shown in FIG. 9, the motion information of the subblocks in the first row and the first column of current block is used to derive the reference samples of each sub-template. In FIG. 9, block 912 corresponds to a current block in current picture 910 and block 922 corresponds to a collocated block in reference picture 920. Each small square in the current block and the collocated block corresponds to a subblock. The dot-filled areas on the left and top of the current block correspond to template for the current block. The boundary subblocks are labelled from A to G. The arrow associated with each subblock corresponds to the motion vector of the subblock. The reference subblocks (labelled as Aref to Gref) are located according to the motion vectors associated with the boundary subblocks.

The present invention discloses techniques to improve the performance of control-point motion vector refinement using a decoder-derived motion vector refinement related method or template matching method.

### BRIEF SUMMARY OF THE INVENTION

Methods and apparatus of video coding using an affine mode are disclosed. According to this method, input data associated with a current block are received where the input data comprise pixel data for the current block to be encoded at an encoder side or coded data associated with the current block to be decoded at a decoder side, and the current block is coded in an affine mode. Two or more CPMVs (Control-Point Motion Vectors) or two or more corner-subblock motions for the current block are determined. Said two or more CPMVs or said two or more corner-subblock motions are refined independently to generate two or more refined CPMVs. A merge list or an AMVP (Advanced Motion Vector Prediction) list comprising said one or more refined CPMVs is generated. The current block is encoded or decoded using a motion candidate selected from the merge list or the AMVP list.

In one embodiment, said two or more CPMVs or said two or more corner-subblock motions are refined using a DMVR (decoder-side motion vector refinement) scheme or an MP-DMVR (multi-pass DMVR) scheme. In one embodiment, an N×N region associated with each of said two or more CPMVs or said two or more corner-subblock motions is used for bilateral matching, and wherein N is a positive integer. In one embodiment, the N is dependent on block size of the current block or picture size. In another embodiment, the N×N region has a same size as affine subblock size of the current block and the N×N region is aligned with a corresponding affine subblock of the current block. In one embodiment, the N×N region is centred at a location of a corresponding CPMV.

In one embodiment, said two or more CPMVs are used to derive said two or more corner-subblock motions.

In one embodiment, said two or more CPMVs or said two or more corner-subblock motions are refined using template matching. In one embodiment, the template matching uses samples within an N×N region centred at each of corresponding CPMVs locations, excluding current samples in the current block and other un-decoded samples, as one or more templates. In another embodiment, the template matching uses samples from N bottom lines of one neighbouring subblock immediately above one corresponding corner subblock and or right M lines of one neighbouring subblock immediately to a left side of one corresponding corner subblock, and wherein the N and M are positive integer.

According to another method, an affine model determined for the current block is applied to neighbouring reference subblocks of the current block to derive affine-transformed reference blocks of neighbouring reference subblocks. One or more templates are determined based on the affine-transformed reference blocks. A set of merge candidates is reordered, based on corresponding cost values measured using said one or more templates, to derive a set of reordered merge candidates. The current block is encoded or decoded using a motion candidate selected from a merge list comprising the set of reordered merge candidates.

In one embodiment, the neighbouring reference subblocks comprise above neighbouring reference subblocks and left neighbouring reference subblocks of the current block. In one embodiment, said one or more templates comprise bottom N lines of the above neighbouring reference subblocks and right M lines of the left neighbouring reference subblocks, and wherein the N and M are positive integer. In one embodiment, the N and M are dependent on block size of the current block or picture size.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of sub-block based affine motion compensation, where the motion vectors for individual pixels of a sub-block are derived according to motion vector refinement.

FIG. 3 illustrates an example of interweaved prediction, where a coding block is divided into sub-blocks with two different dividing patterns and then two auxiliary predictions are generated by affine motion compensation with the two dividing patterns.

FIG. 4 illustrates an example of avoiding motion compensation with 2×H or W×2 block size for the interweaved prediction, where the interweaved prediction is only applied to regions with the size of sub-blocks being 4×4 for both the two dividing patterns.

FIG. 5 illustrates an example of four-parameter affine model, where a current block a reference block is shown.

FIG. 6 illustrates an example of inherited affine candidate derivation, where the current block inherits the affine model of a neighboring block by inheriting the control-point MVs of the neighboring block as the control-point MVs of the current block.

FIG. 7 illustrates an example of Bi-directional Optical Flow (BIO) derived sample-level motion refinement based on the assumptions of optical flow and steady motion.

FIG. 8 illustrates an example of templates used for the current block and corresponding reference blocks to measure matching costs associated with merge candidates.

FIG. 9 illustrates an example of template and reference samples of the template for block with sub-block motion using the motion information of the subblocks of the current block.

FIG. 10 illustrates an example of subblock size which is the same as affine subblock size.

FIG. 11 illustrates another example of subblock size corresponding to N×N regions centred around locations of corresponding CPMVs for bilateral matching.

FIG. 12A-C illustrate examples of template for CPMVs refinement using template matching (template for top-left CPMV in FIG. 12A, template for top-right CPMV in FIG. 12B, and template for bottom-left CPMV in FIG. 12C).

FIG. 13 illustrates another example of template for CPMVs refinement using template matching, where the template includes samples from neighbouring subblocks adjacent to corresponding CPMVs.

FIG. 14 illustrates an example of using a derived affine model on the neighbouring reference blocks if the current block is coded as affine mode according to one embodiment of the present invention.

FIG. 15 illustrates an exemplary flowchart for a video coding system refining CPMVs or corner-subblock motions independently according to an embodiment of the present invention.

FIG. 16 illustrates an exemplary flowchart for a video coding system reordering a set of merge candidates using templates based on the affine-transformed reference blocks according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Proposed Method 1: Affine Motions Refinement with MP-DMVR (Bilateral Matching)

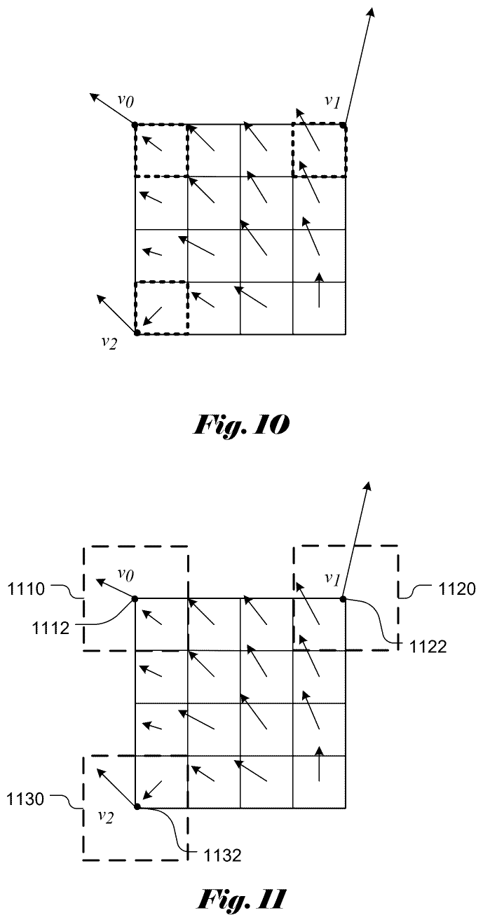

According to this method, motions are refined using MP-DMVR. In one embodiment, 3 CPMVs in 6-parameter affine blocks or 2 CPMVs in 4-parameter affine blocks are refined by MP-DMVR related algorithm independently. With this method, the motions of all subblocks can be shifted by different MV offsets and in addition, the shape of the affine blocks can be further changed. In JVET-AA0144, the MV offsets of 3 or 2 CPMVs derived by MP-DMVR related algorithm are the same, all subblocks in an affine block will be shifted to the same direction. For example, when pass 1 of MP-DMVR of bilateral matching with square search is applied, the top-left, top-right, and bottom-left N×N of an affine block are used for bilateral matching and the corresponding starting MVs are the top-left, top-right, and bottom-left CPMVs. For another example, when pass 2 of MP-DMVR of bilateral matching with diamond shape search regions (DSSR) is used, the top-left, top-right, and bottom-left N×N of an affine block are used for bilateral matching, and the corresponding starting MVs are the top-left, top-right, and bottom-left CPMVs. N can be any pre-defined integer value. N can be design based on CU size or picture size. For another example, pass 3 of MP-DMVR is used. By applying a BDOF related algorithm, the MV offsets of top-left, top-right, and bottom-left CPMVs can be derived independently. The corresponding subblocks are the top-left, top-right, and bottom-left N×N of an affine block. FIG. 10 illustrates an example of subblock size which is the same as affine subblock size. Furthermore, the location of the subblock is fully aligned with the affine subblock as shown in FIG. 10 (i.e., a dash-lined box aligned with a solid-lined box). The subblock size can also be a pre-defined N×N region or can be a region including a pre-defined number of affine subblocks.

For another example, the subblock position of the corresponding CPMVs for bilateral matching can be further refined. For a top-left CPMV, the subblock is an N×N region centred around the top-left position of an affine block (i.e., region 1110 in FIG. 11). For a top-right CPMV, the subblock is a N×N region centred around the top-right position of an affine block (i.e., region 1120 in FIG. 11). For a bottom-left CPMV, the subblock is a N×N region centred around the bottom-left position of an affine block (i.e., region 1130 in FIG. 11). In FIG. 11, the location of a CPMV is as a corner of the current block (e.g., 1112, 1122 or 1132). In other words, the N×N region is centred at the location of a corresponding CPMV in this example.

In one embodiment, MP-DMVR related motion refinement can be performed on the corresponding corner subblock motions. For example, 3 CPMVs are used to derive all subblock motions within an affine block using the optical flow algorithm. After that, motions on top-left, top-right, and bottom-left subblocks of an affine block are used to further derive more precise 3 CPMVs (i.e., improved CPMVs) of the affine block. After that, the improved 3 CPMVs are used to derive all subblock motions of the affine block by the optical flow algorithm. The subblock motions derived in the second round can let the subblock predicted blocks fit original patterns better.

Proposed Method 2: Affine Motions Refinement with Template Matching

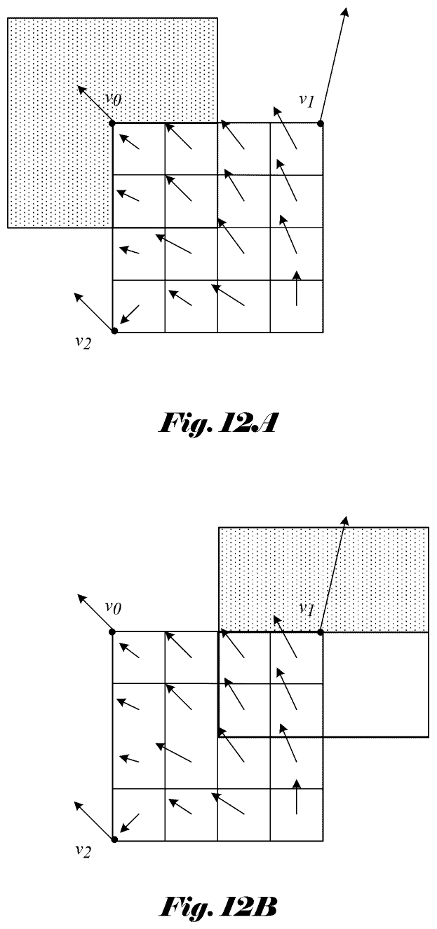

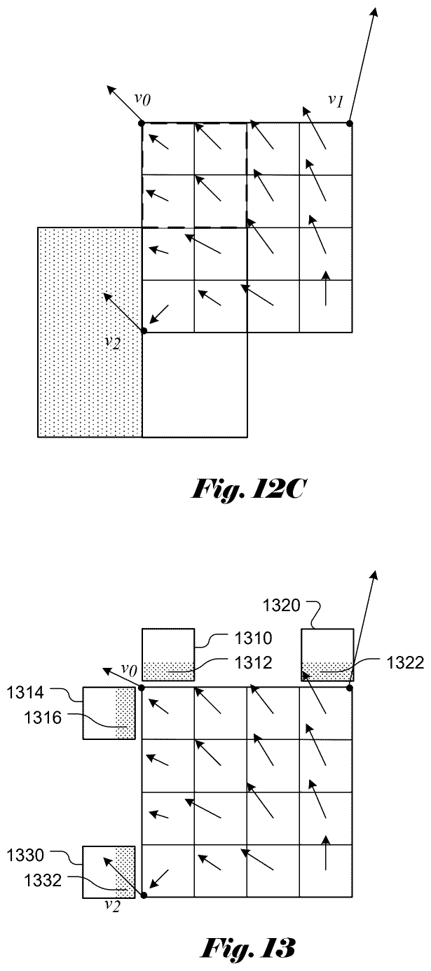

In one embodiment, MP-DMVR related motion refinement method mentioned above can be replaced by template-matching-based (TM-based) motion refinement. According to this embodiment, some samples are used to form the template for template matching. For example, 3 CPMVs are be refined using template matching independently and they are the starting point of template matching as shown in FIGS. 12A-C. For the top-left CPMV, all samples within a N×N region centred around the top-left position of an affine block and not inside the affine block are used to form the template (as indicated by the dot filled region in FIG. 12A) for template matching refinement. For the top-right CPMV, all available samples within an N×N region centred around the top-right position of an affine block, excluding the affine block and the un-coded samples on the right side of the affine block, are used to form the template (as indicated by the dot filled region in FIG. 12B) for template matching refinement. For the bottom-left CPMV, all available samples within an N×N region centred around the bottom-left position of an affine block, excluding the affine block and the un-coded samples on the bottom side of the affine block, are used to form the template (as indicated by the dot filled region in FIG. 12C) for template matching refinement. The following figures show the corresponding templates. In FIGS. 12A-C, the location of a CPMV is as a corner of the current block (e.g., 1112, 1122 or 1132). In other words, the N×N region is centred at the location of a corresponding CPMV in this example.

For another example, 3 CPMVs are refined using template matching independently and they are the starting point of template matching as shown in FIG. 13. For the top-left CPMV, the bottom N lines 1312 of above subblock1310 and right M lines 1316 of left subblock 1314 are used to form the template for template matching refinement. For the top-right CPMV, the bottom N lines 1322 of above subblock 1320 are used to form the template for template matching refinement. For the bottom-left CPMV, the right N lines 1332 of left subblock 1330 are used to form the template for template matching refinement. N and M can be designed according to the CU size.

### Proposed Method 3: Template of Sub-Block Motion Improvement

In JVET-V0099, the above and left reference subblocks are derived according to the subblock affine motions. After that, the above N lines and left M lines of the derived reference blocks are used to form the templates for ARMC. The blocks covered by a rotating object usually have high chance to be coded by affine mode. Therefore, the neighbouring blocks of an affine coded block are usually also coded by affine mode. To make ARMC more effective, it is proposed to perform the derived affine model on the neighbouring reference blocks if the current block is coded as affine mode.

In one embodiment, affine model of current block is performed to the above and left neighbouring reference subblocks and after that, the bottom N lines or very-right M lines of the affine transformed reference blocks of the neighbouring subblocks are used to form the templates for ARMC. Different from JVET-V0099, the proposed method takes the samples of the neighbouring subblocks after performing affine mode. N and M can be any integer value designed based on the CU size or picture size

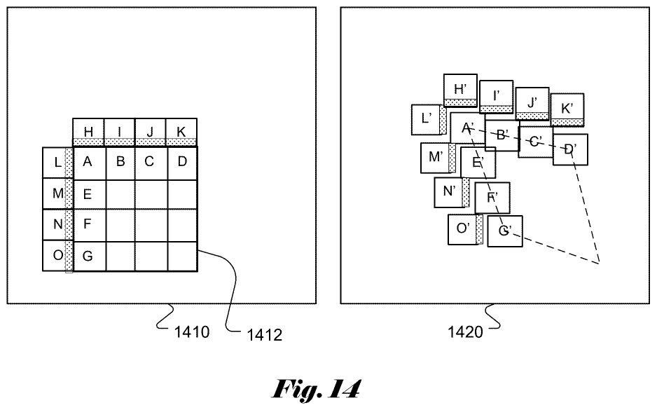

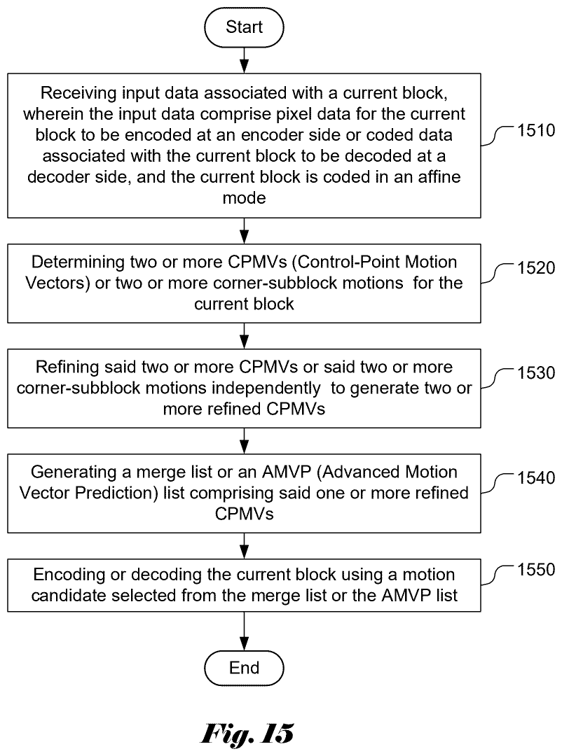

FIG. 14 illustrates an example of using a derived affine model on the neighbouring reference blocks if the current block is coded as affine mode according to one embodiment of the present invention. In FIG. 14, block 1412 corresponds to a current block in current picture 1410, where A, B, C, D, E, F and G are the boundary subblocks on the top and the left of the current block. Picture 1420 corresponds to a reference block and A′, B′, C′, D′, E′, F′ and G′ are the corresponding reference subblocks of the boundary subblocks according to the subblock motions. In JVET-V0099, after finding the neighbouring reference subblocks (i.e., A′, B′, C′, D′, E′, F′ and G′), the sub-templates are generated by directly referencing the top lines and left lines of neighbouring reference subblocks (i.e., A ref, B ref, C ref, D ref, E ref, F ref and G ref) as shown in FIG. 9.

In the corresponding design. H′, I′, J′, K′, L′, M′, N′, and O′ are the affine transformed reference blocks of the neighbouring subblocks according to the subblock motions. In the proposed method, the subblocks covering the top sub-templates are first refined by the derived affine model (i.e., blocks H′, I′, J′ and K′). After that, the bottom N lines of the refined subblocks are used to form the sub-templates of the corresponding subblocks. The subblocks covering the left sub-templates are first refined by the derived affine model (i.e., block L′, M′, N′ and O′). After that, the right M lines of the refined subblocks are used to form the sub-templates of the corresponding subblocks.

In one embodiment, the centre position of a neighbouring reference block is used to derive the motion offset for the corresponding reference block according to the affine model of current block. In another embodiment, a pre-defined position of a neighbouring reference block is used to derive the motion offset for the corresponding reference block according to the affine model of current block. For example, top-left, top-right or bottom-left position.

The above mentioned technology can also be applied to any other tool which uses template matching related algorithm to do motion refinement or list reordering for subblock mode.

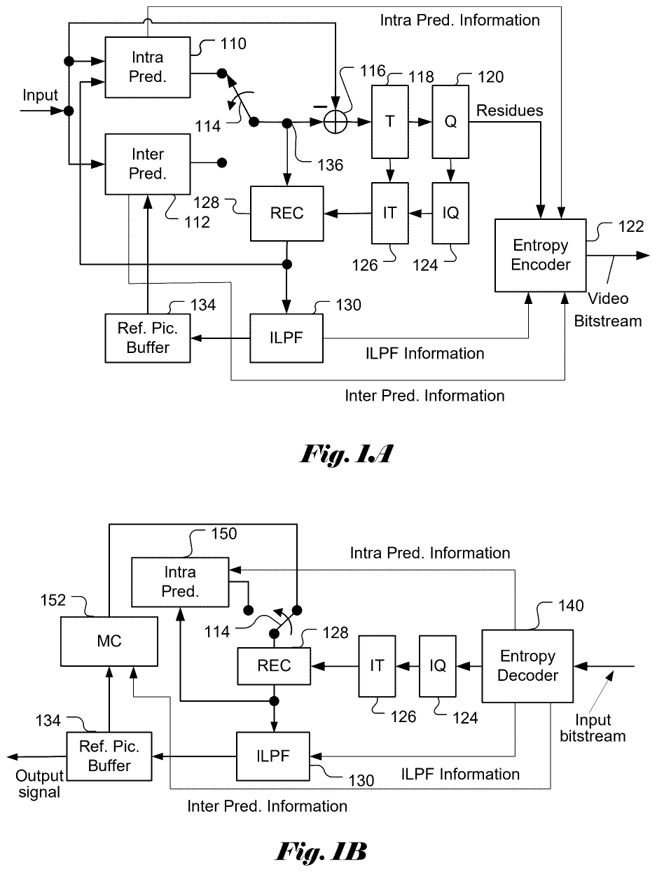

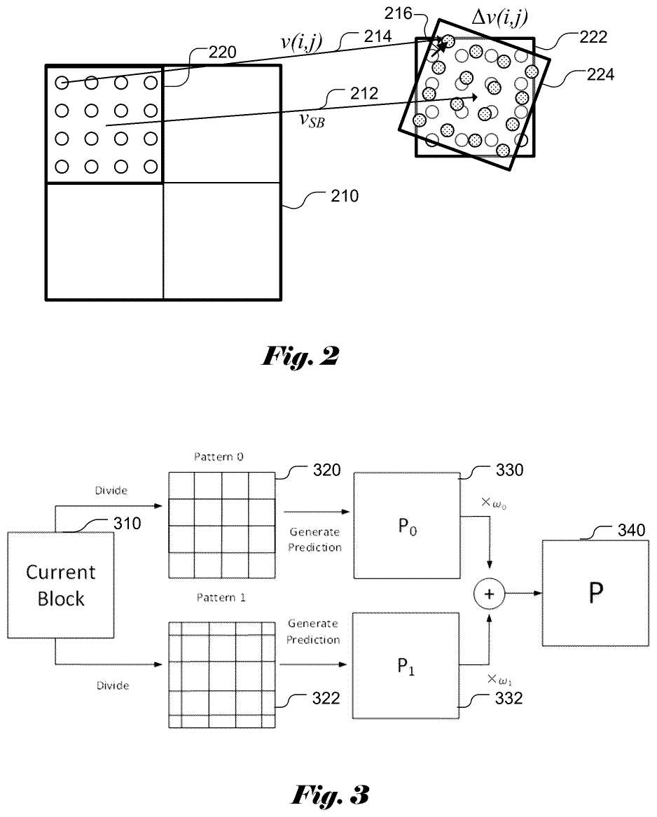

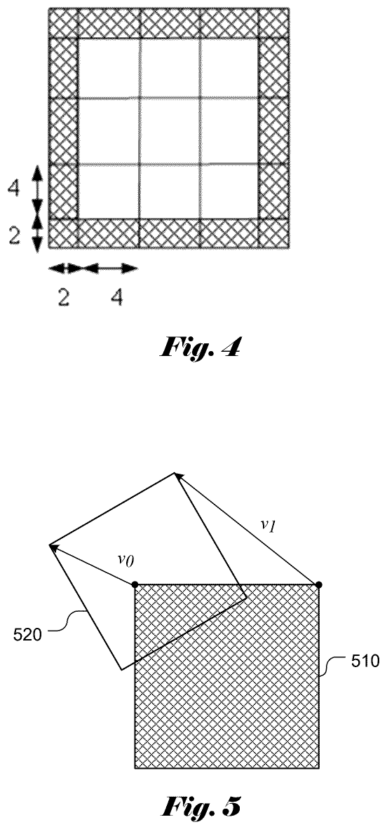

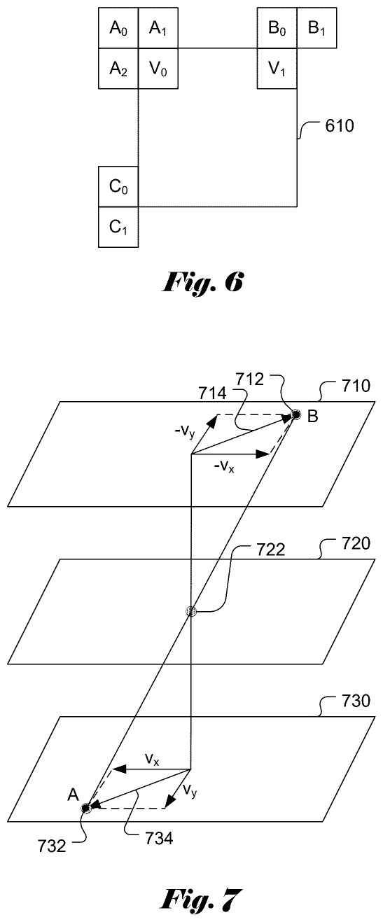

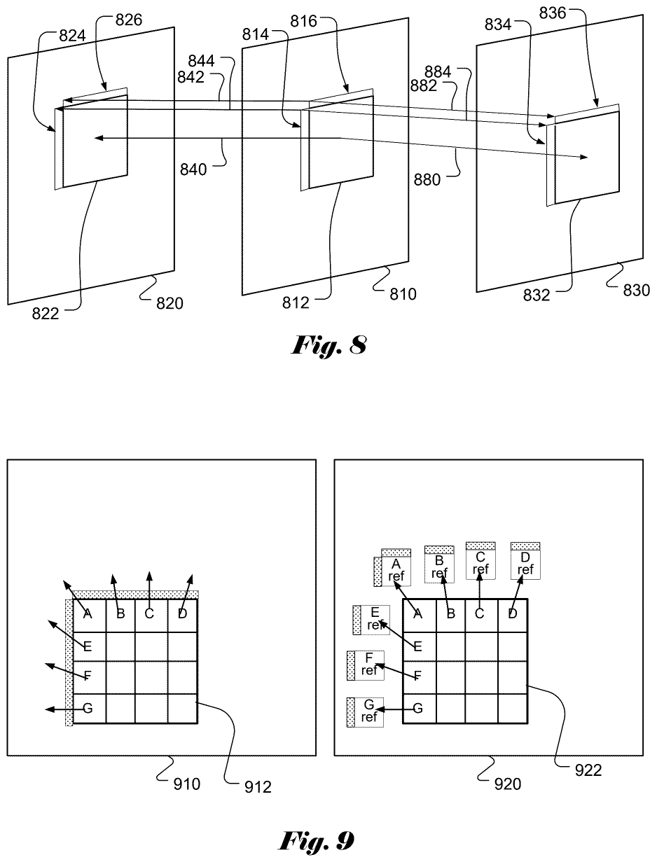

Any of the foregoing proposed methods can be implemented in encoders and/or decoders. For example, any of the proposed methods can be implemented in an affine inter prediction module (e.g. Inter Pred. 112 in FIG. 1A or MC 152 in FIG. 1B) of an encoder and/or a decoder. Alternatively, any of the proposed methods can be implemented as a circuit coupled to affine inter prediction module of the encoder and/or the decoder.

FIG. 15 illustrates an exemplary flowchart for a video coding system refining CPMVs or corner-subblock motions independently according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 1510, wherein the input data comprise pixel data for the current block to be encoded at an encoder side or coded data associated with the current block to be decoded at a decoder side, and the current block is coded in an affine mode. Two or more CPMVs (Control-Point Motion Vectors) or two or more corner-subblock motions are determined for the current block in step 1520. Said two or more CPMVs or said two or more corner-subblock motions are refined independently to generate two or more refined CPMVs in step 1530. A merge list or an AMVP (Advanced Motion Vector Prediction) list comprising said one or more refined CPMVs is generated in step 1540. The current block is encoded or decoded using a motion candidate selected from the merge list or the AMVP list in step 1550.

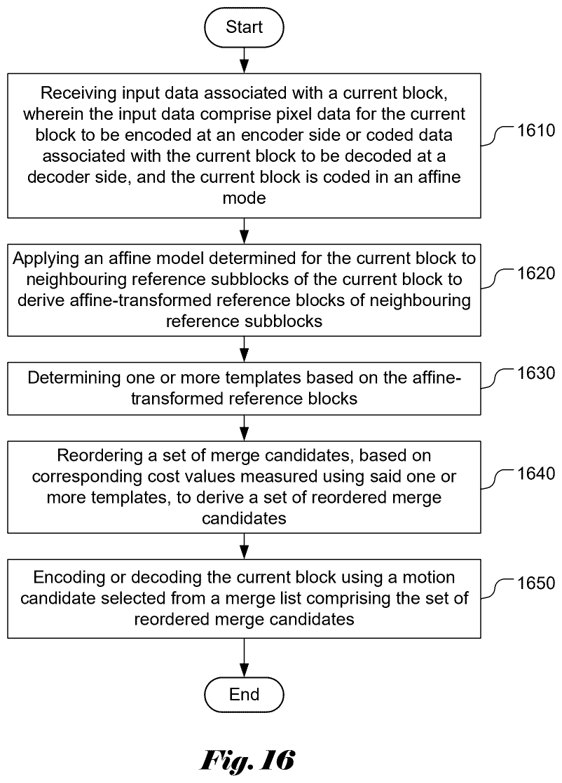

FIG. 16 illustrates an exemplary flowchart for a video coding system reordering a set of merge candidates using templates based on the affine-transformed reference blocks according to an embodiment of the present invention. According to this method, input data associated with a current block are received in step 1610, wherein the input data comprise pixel data for the current block to be encoded at an encoder side or coded data associated with the current block to be decoded at a decoder side, and the current block is coded in an affine mode. An affine model determined for the current block is applied to neighbouring reference subblocks of the current block to derive affine-transformed reference blocks of neighbouring reference subblocks in step 1620. One or more templates are determined based on the affine-transformed reference blocks in step 1630. A set of merge candidates is reordered, based on corresponding cost values measured using said one or more templates, to derive a set of reordered merge candidates in step 1640. The current block is encoded or decoded using a motion candidate selected from a merge list comprising the set of reordered merge candidates in step 1650.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or coded data associated with the current block to be decoded at a decoder side, and the current block is coded in an affine mode;
determining two or more CPMVs (Control-Point Motion Vectors) or two or more corner-subblock motions for the current block;
refining said two or more CPMVs or said two or more corner-subblock motions independently to generate two or more refined CPMVs;
generating a merge list or an AMVP (Advanced Motion Vector Prediction) list comprising said one or more refined CPMVs; and
encoding or decoding the current block using a motion candidate selected from the merge list or the AMVP list.

2. The method of claim 1, wherein said two or more CPMVs or said two or more corner-subblock motions are refined using a DMVR (decoder-side motion vector refinement) scheme or an MP-DMVR (multi-pass DMVR) scheme.

3. The method of claim 2, wherein an N×N region associated with each of said two or more CPMVs or said two or more corner-subblock motions is used for bilateral matching, and wherein N is a positive integer.

4. The method of claim 3, wherein the N is dependent on block size of the current block or picture size.

5. The method of claim 3, wherein the N×N region has a same size as affine subblock size of the current block and the N×N region is aligned with a corresponding affine subblock of the current block.

6. The method of claim 3, wherein the N×N region is centred at a location of a corresponding CPMV.

7. The method of claim 1, wherein said two or more CPMVs are used to derive said two or more corner-subblock motions.

8. The method of claim 1, wherein said two or more CPMVs or said two or more corner-subblock motions are refined using template matching.

9. The method of claim 8, wherein the template matching uses samples within an N×N region centred at each of corresponding CPMVs locations, excluding current samples in the current block and other un-decoded samples, as one or more templates.

10. The method of claim 8, wherein the template matching uses samples from N bottom lines of one neighbouring subblock immediately above one corresponding corner subblock or right M lines of one neighbouring subblock immediately to a left side of one corresponding corner subblock, and wherein the N and M are positive integer.

11. An apparatus for video coding, the apparatus comprising one or more electronic circuits or processors arranged to:
receive input data associated with a current block, wherein the input data comprise pixel data for the current block to be encoded at an encoder side or coded data associated with the current block to be decoded at a decoder side, and the current block is coded in an affine mode;
determine two or more CPMVs (Control-Point Motion Vectors) or two or more corner-subblock motions for the current block;
refine said two or more CPMVs or said two or more corner-subblock motions independently to generate two or more refined CPMVs;
generate a merge list or an AMVP (Advanced Motion Vector Prediction) list comprising said one or more refined CPMVs; and
encode or decode the current block using a motion candidate selected from the merge list or the AMVP list.

12. A method of video coding, the method comprising:
receiving input data associated with a current block, wherein the input data comprise pixel data for the current block to be encoded at an encoder side or coded data associated with the current block to be decoded at a decoder side, and the current block is coded in an affine mode;
applying an affine model determined for the current block to neighbouring reference subblocks of the current block to derive affine-transformed reference blocks of neighbouring reference subblocks;
determining one or more templates based on the affine-transformed reference blocks;
reordering a set of merge candidates, based on corresponding cost values measured using said one or more templates, to derive a set of reordered merge candidates; and
encoding or decoding the current block using a motion candidate selected from a merge list comprising the set of reordered merge candidates.

13. The method of claim 12, wherein the neighbouring reference subblocks comprise above neighbouring reference subblocks and left neighbouring reference subblocks of the current block.

14. The method of claim 13, wherein said one or more templates comprise bottom N lines of the above neighbouring reference subblocks and right M lines of the left neighbouring reference subblocks, and wherein the N and M are positive integer.

15. The method of claim 14, wherein the N and M are dependent on block size of the current block or picture size.

16. An apparatus for video coding, the apparatus comprising one or more electronic circuits or processors arranged to:
receive input data associated with a current block, wherein the input data comprise pixel data for the current block to be encoded at an encoder side or coded data associated with the current block to be decoded at a decoder side, and the current block is coded in an affine mode;
apply an affine model determined for the current block to neighbouring reference subblocks of the current block to derive affine-transformed reference blocks of neighbouring reference subblocks;
determine one or more templates based on the affine-transformed reference blocks;
reorder a set of merge candidates, based on corresponding cost values measured using said one or more templates, to derive a set of reordered merge candidates; and
encode or decode the current block using a motion candidate selected from a merge list comprising the set of reordered merge candidates.
